(19) United States
(12) Patent Application Publication
(10) Pub. No.: US 2018/0341769 A1
(43) Pub. Date: Nov. 29, 2018

(54) THREAT DETECTION METHOD AND THREAT DETECTION DEVICE

(71) Applicant: FUJITSU LIMITED, Kawasaki-shi (JP)

(72) Inventor: Soya Aoyama, Fuchu (JP)

(73) Assignee: FUJITSU LIMITED, Kawasaki-shi (JP)

(21) Appl. No.: 15/983,902

(22) Filed: May 18, 2018

(30) Foreign Application Priority Data
May 29, 2017 (JP) 2017-105951

(51) Int. Cl. G06F 21/55; G06F 17/30; G06F 21/56

(52) U.S. Cl. CPC G06F 21/552; G06F 2221/034; G06F 21/56; G06F 17/30312

(57) ABSTRACT

A threat detection method includes storing path information of an existing file in a first storage in response to a start of an application, determining, in response to detection of an event of access to a first file, whether or not path information of the first file is stored in the first storage, storing the path information of the first file in a second storage when the path of the first file is not stored in the first storage, obtaining first threat information of a parent process of a first process in response to an event of generation of the first process, determining a threat level of the first process in accordance with both the first threat information and a result of determination of whether path information of a second file as a generation source of the first process is stored in the second storage.

### CROSS-REFERENCE TO RELATED APPLICATION

This application is based upon and claims the benefit of priority of the prior Japanese Patent Application No. 2017-105951, filed on May 29, 2017, the entire contents of which are incorporated herein by reference.

### FIELD

The embodiments discussed herein are related to a threat detection technology.

### BACKGROUND

There is a method of detecting malware posing a threat such as a computer virus, a worm, or spyware maliciously infecting an apparatus on a network. For detection of this malware posing a threat, there is an antivirus software which is based on pattern matching using a virus definition database. For example, there is a technology which verifies propriety of document configuration files by comparing the hash value of a document configuration file obtained from a server with the hash value of a document configuration file stored by a storage section. A related technology is disclosed in Japanese Laid-open Patent Publication No. 2007-293433, for example.

### SUMMARY

According to an aspect of the invention, a threat detection method includes storing path information of an existing file in a first storage in response to a start of an application, determining, in response to detection of an event of access to a first file, whether or not path information of the first file is stored in the first storage, storing the path information of the first file in a second storage when the path of the first file is not stored in the first storage, obtaining first threat information of a parent process of a first process in response to an event of generation of the first process, determining a threat level of the first process in accordance with both the first threat information and a result of determination of whether path information of a second file as a generation source of the first process is stored in the second storage.

This object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram illustrating an example of a functional configuration of an information processing device according to an embodiment;

FIG. 2 is a diagram of assistance in explaining setting of a threat level;

FIG. 3 is a diagram of assistance in explaining a process database, a file database, and a suspicious file database;

FIG. 4 is a flowchart illustrating an example of operation of an information processing device according to the embodiment; and

FIG. 5 is a block diagram illustrating an example of a hardware configuration of an information processing device according to the embodiment.

### DESCRIPTION OF EMBODIMENTS

It may be difficult to detect unknown malware as a threat. Malware, for example, includes a “downloader” and a “dropper.” The “downloader” and the “dropper” have a function of simply downloading and executing a file, and are therefore not detected as malware when sent as an email attachment or the like. However, when a user executes the “downloader” and “dropper” sent as an email attachment or the like, the “downloader” and the “dropper” download and execute the body of malware. The downloaded body of the malware may be subspecies derived in various manners, and may include unknown malware not included in a virus definition database.

A threat detection program, a threat detection method, and an information processing device according to embodiments will hereinafter be described with reference to the drawings. Configurations having identical functions in the embodiments are identified by the same reference numerals, and repeated description thereof will be omitted. Incidentally, the threat detection program, the threat detection method, and the information processing device described in the following embodiments merely represent an example, and do not limit the embodiments. In addition, the following embodiments may be combined with each other as appropriate within a scope where no inconsistency arises.

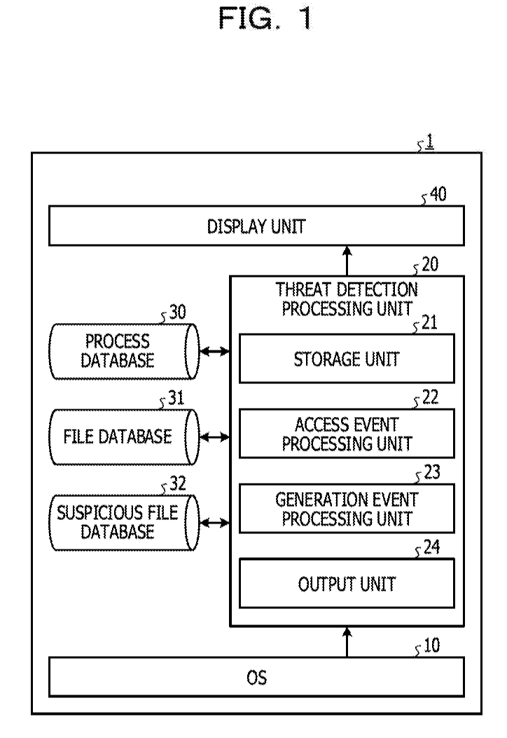

FIG. 1 is a block diagram illustrating an example of a functional configuration of an information processing device according to an embodiment. An information processing device 1 according to the embodiment is, for example, a computer such as a personal computer (PC) or a tablet terminal. As illustrated in FIG. 1, the information processing device 1 includes an operating system (OS) 10, a threat detection processing unit 20, a process database 30, a file database 31, a suspicious file database 32, and a display unit 40.

The information processing device 1 implements functions as the threat detection processing unit 20 by executing a threat detection program under an execution environment of the OS 10.

The OS 10 such as Windows (registered trademark) gives a process accompanying execution of a program a process identifier (ID) identifying the process, and manages generation, execution, and deletion of each process. The OS 10 also manages file access in a file system.

The threat detection processing unit 20 performs threat detection processing that detects malware as a threat such as a computer virus, a worm or spyware that maliciously infects an apparatus, and which outputs an alert.

For example, rather than performing pattern matching type malware detection utilizing a virus definition database or the like, the threat detection processing unit 20 detects malware by monitoring a process based on an application program or the like, and grasping various events occurring when malware operates.

The malware such as the “downloader” and the “dropper” is not detected as malware when sent in a state of being attached to an email, and downloads and executes the body of the malware when a user executes the malware. Hence, with regard to a file created when a file attached to the email is executed, the malware may be detected based on an idea that the execution of an unknown file is a suspicious event related to the malware. For example, a threat level indicating a degree of suspiciousness as malware is set to a file newly created after a start of an email application or the like, and a threat level is similarly set also to a process generated by executing the file. Then, malware detection is output when the threat level of the process is equal to or more than a given value.

For example, the threat detection processing unit 20 sets a threat level related to malware to a file and a process newly generated after a start of an email application or the like based on events such as the start of the application on the OS 10, file access and the generation of the process. In addition, the threat detection processing unit 20 determines the threat level of the process based on the threat level of a parent process of the process and a result of determination of whether or not the file as a generation source of the process is a file newly created after the start of the application.

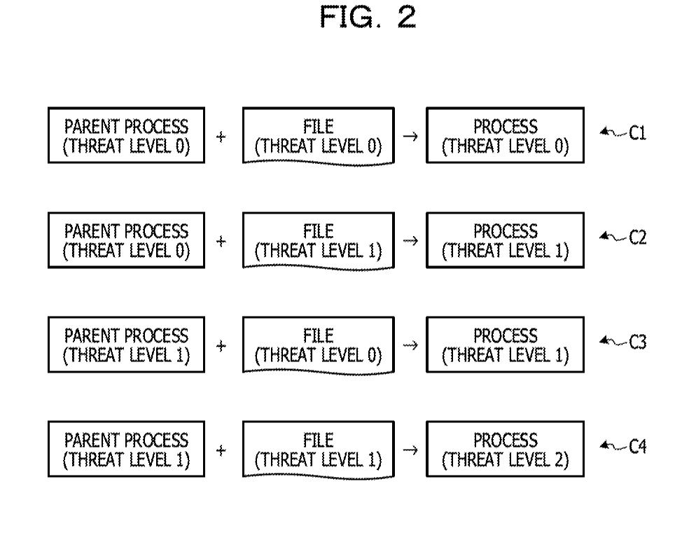

FIG. 2 is a diagram of assistance in explaining setting of a threat level. As in cases C1 to C4 in FIG. 2, in the present embodiment, the threat level of a process is determined based on the threat level of a parent process of the process and the threat level of a file as a generation source of the process (result of determination of whether or not the file as the generation source of the process is a file newly created after a start of an application).

In the case C1, for example, the threat level of the parent process of the process is zero. In addition, the file as the generation source of the process is not a file newly created after the start of the application, and has a threat level of zero. Such a process is not a suspicious event related to malware. The threat level of the process is therefore determined to be zero.

In addition, in the cases C2 and C3, one of the threat level of the parent process of the process and the threat level of the file as the generation source of the process is one. For example, the threat level of the parent process of the process is determined to be one, or the file as the generation source of the process is a file newly created after the start of the application. Such a process partially falls under suspicious events related to malware, such as the execution of a file newly created after the start of the application. The threat level of the process is therefore determined to be one, which is higher than zero by one level.

In addition, in the case C4, both the threat level of the parent process of the process and the threat level of the file as the generation source of the process are one. Such a process falls under suspicious events related to malware, such as the execution of a file newly created after the start of the application. The threat level of the process is therefore determined to be two, which is further higher than one by one level.

Next, the threat detection processing unit 20 outputs a warning related to malware according to the determined threat level. Even when unknown malware is executed, the unknown malware being not yet registered in a virus definition database or the like due to an attack method such as the “downloader” and the “dropper,” such malware detection enables the information processing device 1 to detect the unknown malware as a threat.

The threat detection processing unit 20 includes a storage unit 21, an access event processing unit 22, a generation event processing unit 23, and an output unit 24. The storage unit 21 obtains path information of each file from the OS 10 in response to an event of an application start on the OS 10, and stores the path information in the file database 31. For example, the storage unit 21 obtains, from the OS 10, the path information of each file in response to a start of an application by using an application programming interface (API) related to the OS 10, and stores the obtained path information in the file database 31.

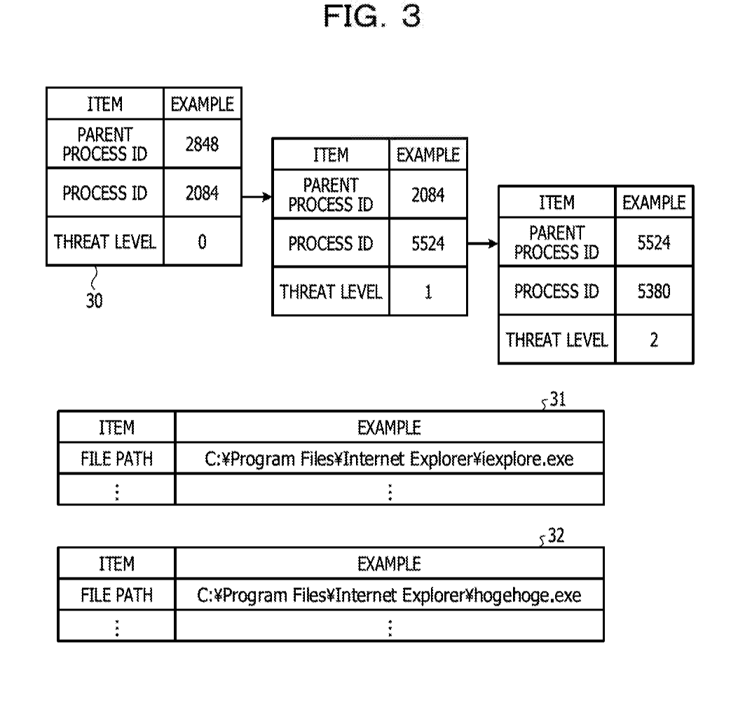

FIG. 3 is a diagram of assistance in explaining a process database, a file database, and a suspicious file database. The process database, the file database, and the suspicious file database may be the process database 30, the file database 31, and the suspicious file database 32, respectively, depicted in FIG. 1. As illustrated in FIG. 3, the file database 31 is a database that stores information of each file such as a file path. The file database 31 is an example of a first storage unit.

Incidentally, the event of an application start is the event of a start of an arbitrary application such as a standard browser or electronic mail, and the type of the application or the like is not particularly limited.

The access event processing unit 22 detects an event of access to a file after the start of the application via the API related to the OS 10. Next, the access event processing unit 22 refers to the file database 31 in response to the detection of the access event, and determines whether or not the path information of the file as an access destination in the access event is stored in the file database 31. When this determination indicates that the path of the file as the access destination is not stored in the file database 31, the access event processing unit 22 stores the path information of the file as the access destination in the suspicious file database 32.

As illustrated in FIG. 3, the suspicious file database 32 is a database that manages the information (file path or the like) of the file (suspicious file) newly created after the start of the application. The suspicious file database 32 is an example of a second storage unit.

The generation event processing unit 23 detects an event of generation of a process after the start of the application via the API related to the OS 10. Next, the generation event processing unit 23 refers to the process database 30 that manages information of each process in response to the detection of the event of generation of the process, and obtains threat information (threat level) of a parent process of the generated process.

As illustrated in FIG. 3, the process database 30 is a database that stores, for each process, information related to the process, such as the threat level set to the process together with identification information (a process ID and a parent process ID) identifying the process and the parent process of the process. The process database 30 is an example of a third storage unit.

In addition, the generation event processing unit 23 refers to the suspicious file database 32 in response to the detection of the event of generation of the process, and determines whether or not the file as the generation source of the process is stored in the suspicious file database 32. Next, the generation event processing unit 23 determines the threat level of the generated process based on the obtained threat information of the parent process and a result of the determination of whether or not the file as the generation source of the process is stored in the suspicious file database 32. Next, the generation event processing unit 23 outputs a result of the determination for the generated process to the output unit 24.

For example, in cases such as the case C1 in FIG. 2, the generation event processing unit 23 determines that the threat level of the generated process is zero. In addition, in cases such as the cases C2 and C3 in FIG. 2, the generation event processing unit 23 determines that the threat level of the generated process is one. In addition, in cases such as the case C4 in FIG. 2, the generation event processing unit 23 determines that the threat level of the generated process is two.

Thus, the generation event processing unit 23 may determine the threat level of a process according to the number of applicable suspicious events (conditions) related to malware. For example, the threat level is set to one when the threat level of the parent process of the process is determined to be one, or when the file as the generation source of the process is a file newly created after the start of the application. In addition, the threat level is set to two when both of the above conditions are met. By thus determining the threat level, it is possible to evaluate the threat of malware according to the number of observations of a suspicious event related to malware.

The output unit 24 stores the threat level determined by the generation event processing unit 23 in the process database 30 in association with the identification information (process ID) of the generated process, and outputs a warning indicating the presence of the process related to malware according to the determined threat level.

Incidentally, the warning output by the output unit 24 may be given when the threat level is equal to or more than a given threshold value, or may be given for each step of the threat level. For example, when the threat level is one, a warning to a degree that the threat of malware is suspected, such as “there is a process in which the execution of malware is suspected,” is output. In addition, when the threat level is two, a warning indicating that the threat of malware is definite, such as “there is a process corresponding to the execution of malware,” is output.

In addition, the output of the warning on the output unit 24 includes, for example, a pop-up message on the display unit 40 and balloon display. In addition, the output unit 24 may output the warning by transmitting an email to a given address via a communicating unit (not illustrated). In addition, the generation event processing unit 23 may output the warning as a recording in a log file (not illustrated). A user may recognize a malware attack (presence of a process related to malware) by checking these outputs.

The display unit 40 performs display output to a display or the like. For example, the display unit 40 displays an alert output by the process database 30 on the display or the like. The user may thereby check the content of the alert.

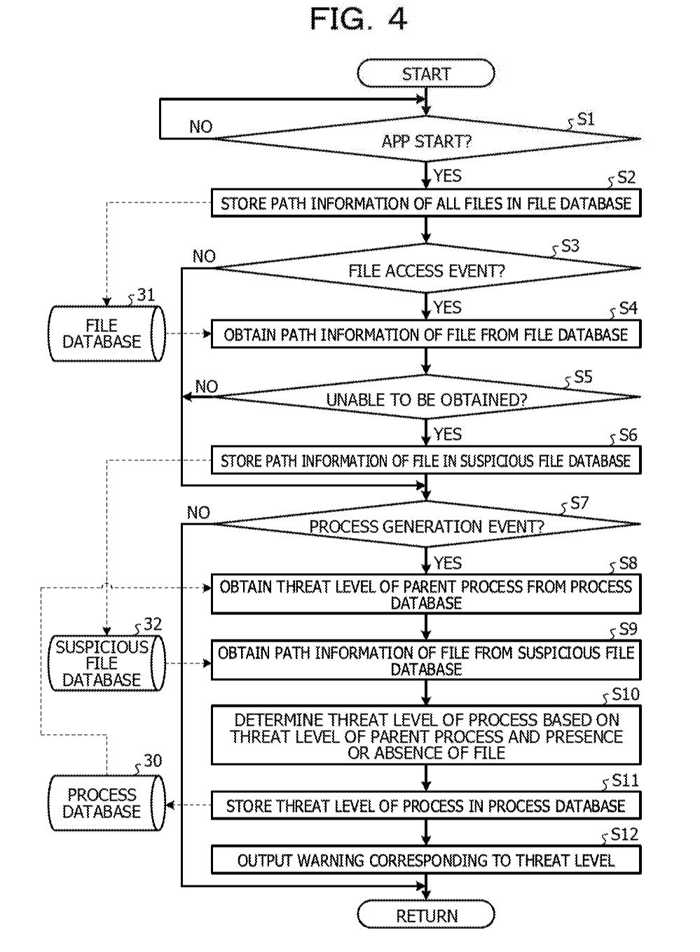

FIG. 4 is a flowchart illustrating an example of operation of an information processing device according to the embodiment. The information processing device may be the information processing device 1 depicted in FIG. 1. As illustrated in FIG. 4, when processing is started, the storage unit 21 determines whether or not an application is started (app start) based on information obtained from the OS 10 via the API (S1). When there is no app start (S1: NO), the storage unit 21 sets the processing in a waiting state.

When there is an app start (S1: YES), the storage unit 21 obtains the path information of all files from the OS 10, and stores the obtained path information of each of the files in the file database 31 (S2).

Next, the access event processing unit 22 determines whether or not there is an event of access to a file (file access event) based on information obtained from the OS 10 via the API (S3). When no file access event has occurred (S3: NO), the access event processing unit 22 advances the processing to S7.

When a file access event has occurred (S3: YES), the access event processing unit 22 obtains the path information of the file as a target of the access event from the file database 31 (S4), and determines whether or not the path information is obtained (S5).

When the path information is not obtained (S5: YES), the file as the target of the access event is a file newly created after the app start. The access event processing unit 22 therefore stores the path information of the file of the access event in the suspicious file database 32 (S6).

When the path information is obtained (S5: NO), the file as the target of the access event is not a file newly created after the app start. The access event processing unit 22 therefore advances the processing to S7 without storing the path information of the file of the access event in the suspicious file database 32.

Next, the generation event processing unit 23 determines whether or not there is an event of generation of a process (process generation event) based on information obtained from the OS 10 via the API (S7). When no process generation event has occurred (S7: NO), the generation event processing unit 23 returns the processing.

When a process generation event has occurred (S7: YES), the generation event processing unit 23 obtains the threat level of a parent process of the generated process from the process database 30 (S8). Next, the generation event processing unit 23 obtains the path information of a file as a generation source of the generated process from the suspicious file database 32 (S9).

Next, the generation event processing unit 23 determines the threat level of the process based on the threat level of the parent process obtained in S8 and whether or not the path information is obtained from the suspicious file database 32 in S9, for example, whether or not the file as the generation source of the generated process is present in the suspicious file database 32 (S10). For example, the generation event processing unit 23 determines the threat level of the process as in the cases C1 to C4 in FIG. 2.

Next, the output unit 24 stores the threat level of the process in the process database 30 based on a result of the determination in S10 (S11). Next, the output unit 24 outputs a warning indicating the presence of the process related to malware according to the determined threat level (S12).

As described above, the storage unit 21 of the information processing device 1 stores the path information of files in the file database 31 in response to a start of an application. In addition, in response to detection of an event of access to a file after the start of the application, the access event processing unit 22 of the information processing device 1 determines whether or not the path information of the file as an access destination is stored in the file database 31. When this determination indicates that the path of the file as the access destination is not stored in the file database 31, the access event processing unit 22 stores the path of the file as the access destination in the suspicious file database 32. In response to an event of generation of a process after the start of the application, the generation event processing unit 23 of the information processing device 1 refers to the process database 30 storing the threat information (threat levels) of processes, and obtains the threat information of a parent process of the process. In addition, the generation event processing unit 23 determines the threat level of the process based on the obtained threat information of the parent process and a result of determination of whether or not a file as a generation source of the process is stored in the suspicious file database 32. The output unit 24 of the information processing device 1 stores the threat level determined by the generation event processing unit 23 in the process database 30 in association with the process, and outputs a warning corresponding to the determined threat level.

Thus, even when unknown malware is executed, the unknown malware being not yet registered in a virus definition database or the like due to an attack method such as the “downloader” and the “dropper,” the information processing device 1 may detect the unknown malware as a threat.

It is to be noted that the respective constituent elements of each device illustrated in the figures do not necessarily need to be physically configured as illustrated in the figures. For example, concrete forms of distribution and integration of each device are not limited to those illustrated in the figures, and the whole or a part of each device may be configured so as to be distributed and integrated functionally or physically in arbitrary units according to various kinds of loads, usage conditions, or the like.

In addition, the whole or an arbitrary part of various kinds of processing functions performed in the information processing device 1 may be performed on a central processing unit (CPU) (or a microcomputer such as a micro processing unit (MPU) or a micro controller unit (MCU)). In addition, it is needless to say that the whole or an arbitrary part of the various kinds of processing functions may be performed on a program analyzed and executed by a CPU (or a microcomputer such as an MPU or an MCU) or on hardware based on wired logic. In addition, the various kinds of processing functions performed in the information processing device 1 may be performed by cloud computing with a plurality of computers in cooperation with each other.

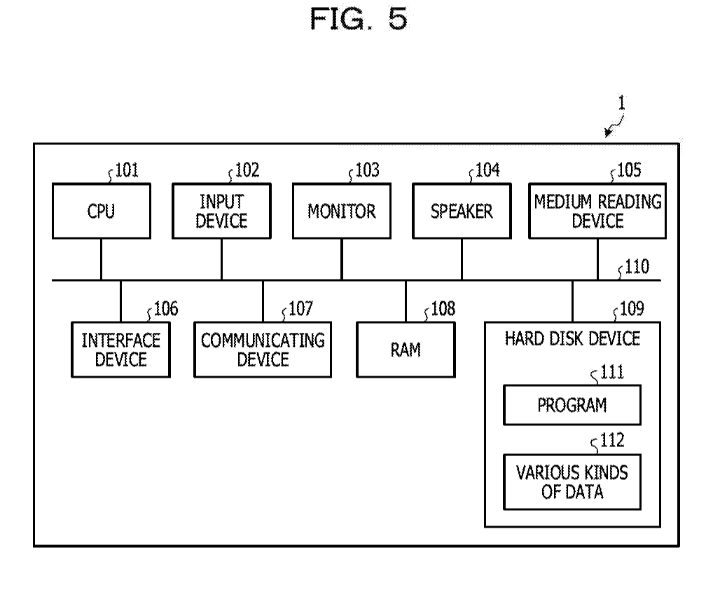

Various kinds of processing described in the foregoing embodiment may be implemented by executing a program prepared in advance on a computer. Accordingly, the following description will be made of an example of a computer (hardware) that executes a program having functions similar to those of the foregoing embodiment. FIG. 5 is a block diagram illustrating an example of a hardware configuration of an information processing device according to the embodiment. The information processing device may be the information processing device 1 depicted in FIG. 1.

As illustrated in FIG. 5, the information processing device 1 includes a CPU 101 configured to perform various kinds of arithmetic processing, an input device 102 configured to receive data input, a monitor 103, and a speaker 104. The information processing device 1 also includes a medium reading device 105 configured to read a program or the like from a storage medium, an interface device 106 for coupling with various kinds of devices, and a communicating device 107 for communication coupling with an external apparatus by wire or radio. The information processing device 1 also includes a random access memory (RAM) 108 configured to temporarily store various kinds of information and a hard disk device 109. In addition, the units (101 to 109) within the information processing device 1 are coupled to a bus 110.

The hard disk device 109 stores a program 111 for performing various kinds of processing by the storage unit 21, the access event processing unit 22, the generation event processing unit 23, and the output unit 24 in the threat detection processing unit 20 described in the foregoing embodiment and the like. The hard disk device 109 also stores various kinds of data 112 that the program 111 refers to. The input device 102, for example, receives an input of operation information from an operator of the information processing device 1. The monitor 103, for example, displays various kinds of screens to be operated by the operator. The interface device 106 is, for example, coupled to a printing device. The communicating device 107 is coupled to a communication network such as a local area network (LAN), and exchanges various kinds of information with an external apparatus via the communication network.

The CPU 101 performs various kinds of processing by reading the program 111 stored in the hard disk device 109, expanding the program 111 in the RAM 108, and executing the program 111. Incidentally, the program 111 may not be stored in the hard disk device 109. For example, the program 111 stored on a storage medium readable by the information processing device 1 may be read and executed. A portable recording medium such as a compact disc read only memory (CD-ROM), a digital versatile disk (DVD) or a universal serial bus (USB) memory, a semiconductor memory such as a flash memory, or a hard disk drive, for example, corresponds to the storage medium readable by the information processing device 1. In addition, the program 111 may be stored in devices coupled to a public circuit, the Internet, a LAN, or the like, and the information processing device 1 may read the program 111 from these devices and execute the program 111.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A threat detection method executed by a computer, the threat detection method comprising:
storing path information of an existing file in a first storage in response to a start of an application;
determining, in response to detection of an event of access to a first file after the start of the application, whether or not path information of the first file is stored in the first storage;
storing the path information of the first file in a second storage when the path information of the first file is not stored in the first storage;
by referring to a third storage configured to store threat information of each process, obtaining first threat information of a parent process of a first process in response to an event of generation of the first process after the start of the application;
determining a threat level of the first process in accordance with both the first threat information of the parent process and a result of determination of whether path information of a second file as a generation source of the first process is stored in the second storage; and
storing the threat level of the first process in the third storage in association with the first process and performing output relative to the threat level of the first process.

2. The threat detection method according to claim 1, wherein
the determining of the threat level of the first process includes setting a first threat level as the threat level of the first process when one of two conditions is satisfied, the two conditions being a condition that the first threat information of the parent process indicates a threat and a condition that the path information of the second file is stored in the second storage, and setting a second threat level higher than the first threat level as the threat level of the first process when both of the two conditions are satisfied.

3. The threat detection method according to claim 1, wherein the path information of the existing file is obtained by using an application programming interface related to an operating system.

4. The threat detection method according to claim 1, wherein the result of the determination of whether the path information of the second file is stored in the second storage represents a result of determination of whether or not the second file is a file newly created after the start of the application.

5. The threat detection method according to claim 1, wherein the output relative to the threat level of the first process is a warning related to malware.

6. A threat detection device comprising:
a memory; and
a processor coupled to the memory and the processor configured to:
store path information of an existing file in a first storage in response to a start of an application;
determine, in response to detection of an event of access to a first file after the start of the application, whether or not path information of the first file is stored in the first storage;
store the path information of the first file in a second storage when the path information of the first file is not stored in the first storage;
by referring to a third storage configured to store threat information of each process, obtain first threat information of a parent process of a first process in response to an event of generation of the first process after the start of the application;
perform determination of a threat level of the first process in accordance with both the first threat information of the parent process and a result of determination of whether path information of a second file as a generation source of the first process is stored in the second storage; and
store the threat level of the first process in the third storage in association with the first process and perform output relative to the threat level of the first process.

7. The threat detection device according to claim 6, wherein the determination of the threat level of the first process includes setting a first threat level as the threat level of the first process when one of two conditions is satisfied, the two conditions being a condition that the first threat information of the parent process indicates a threat and a condition that the path information of the second file is stored in the second storage, and setting a second threat level higher than the first threat level as the threat level of the first process when both of the two conditions are satisfied.

8. The threat detection device according to claim 6, wherein the path information of the existing file is obtained by using an application programming interface related to an operating system.

9. The threat detection device according to claim 6, wherein the result of the determination of whether the path information of the second file is stored in the second storage represents a result of determination of whether or not the second file is a file newly created after the start of the application.

10. The threat detection device according to claim 6, wherein the output relative to the threat level of the first process is a warning related to malware.

11. A non-transitory computer-readable medium storing a threat detection program that causes a computer to execute a process comprising:
storing path information of an existing file in a first storage in response to a start of an application;
determining, in response to detection of an event of access to a first file after the start of the application, whether or not path information of the first file is stored in the first storage;
storing the path information of the first file in a second storage when the path information of the first file is not stored in the first storage;
by referring to a third storage configured to store threat information of each process, obtaining first threat information of a parent process of a first process in response to an event of generation of the first process after the start of the application;
determining a threat level of the first process in accordance with both the first threat information of the parent process and a result of determination of whether path information of a second file as a generation source of the first process is stored in the second storage; and
storing the threat level of the first process in the third storage in association with the first process and performing output relative to the threat level of the first process.

12. The non-transitory computer-readable medium according to claim 11, wherein the determining of the threat level of the first process includes setting a first threat level as the threat level of the first process when one of two conditions is satisfied, the two conditions being a condition that the first threat information of the parent process indicates a threat and a condition that the path information of the second file is stored in the second storage, and setting a second threat level higher than the first threat level as the threat level of the first process when both of the two conditions are satisfied.

13. The non-transitory computer-readable medium according to claim 11, wherein the path information of the existing file is obtained by using an application programming interface related to an operating system.

14. The non-transitory computer-readable medium according to claim 11, wherein the result of the determination of whether the path information of the second file is stored in the second storage represents a result of determination of whether or not the second file is a file newly created after the start of the application.

15. The non-transitory computer-readable medium according to claim 11, wherein the output relative to the threat level of the first process is a warning related to malware.
